(19) United States
(12) Patent Application Publication
(10) Pub. No.: US 2001/0017081 A1
(43) Pub. Date: Aug. 30, 2001

(54) Adsorbent for dioxins

(76) Inventors: Katsuhisa Honda, Matsuyama-shi (JP); Muneki Ohuchi, Matsuyama-shi (JP); Masazumi Yamashita, Matsuyama-shi (JP); Hirofumi Nakamura, Matsuyama-shi (JP)

Correspondence Address: BIRCH STEWART KOLASCH & BIRCH, PO BOX 747, FALLS CHURCH, VA, 22040-0747, US

(21) Appl. No.: 09/782,179

(22) Filed: Feb. 14, 2001

(30) Foreign Application Priority Data
Feb. 14, 2000 (JP) 2000-34941

(51) Int. Cl. B01D 53/02

(52) U.S. Cl. 96/108; 502/414

(57) ABSTRACT

Disclosed is an adsorbent for dioxins which is capable of enough removing dioxins in exhaust gas even with large amounts of tar components, being usable at high temperatures and capable of enough removing dioxins even at high temperatures. The adsorbent for dioxins contains at least one kind selected from among activated alumina, iron-type zeolite, aluminum-type zeolite, potassium-type zeolite and silica.

### BACKGROUND OF THE INVENTION

The present invention relates to an adsorbent for dioxins (which term means “dioxins” provided at Article 2 of the Law Concerning Special Measures against Dioxins in Japan (Law No. 105 of 1999), that is, dioxins are herein used as a generic term for “polychlorinated dibenzofurans, polychlorodibenzo-para-dioxins, and co-planar polychlorinated biphenyls”; the same applies hereinafter). More specifically, the invention relates to an adsorbent capable of efficiently adsorbing dioxins contained in incomplete combustion components (containing brownish black oily matters, i.e. tar components; hereinafter, referred to as “tar components”) in exhaust gas at incineration facilities for refuse, industrial wastes and the like.

Exhaust gas generated from incineration facilities provided for incineration treatment of industrial wastes, general domestic refuse and the like contains dioxins. Dioxins, as well known, cause skin or visceral disorders and have teratogenicity or carcinogenicity, being unparalleled highly toxic substances. Among other dioxins in narrow sense, 2,3,7,8-tetrachlorodibenzo-p-dioxin is said to be one of the most toxic substances that mankind has ever obtained. The other dioxins are also harmful to human body, and the toxicity of polychlorinated biphenyls (PCBs) has been taken as an issue, where co-planar PCBs have a particularly toxic planar structure among other PCBs.

In recent years, there have been pointed out various pollution issues due to such highly toxic dioxins. In particular, it has been found out that some dioxins are produced from refuse incineration, adding to the issues. That is, depending on the operating conditions of the incineration plant, dioxins are produced from the refuse incineration. Then, the produced dioxins may be included into fly ash exhausted from the incineration plant or exhausted from chimneys as exhaust gas derived from the refuse incineration, resulting in such problems as soil pollution around the incineration plant.

Under these and other circumstances, there has been a desire for development of an adsorbent capable of adsorbing and removing dioxins from such exhaust gas.

### SUMMARY OF THE INVENTION

Hitherto, activated carbon has been known as an adsorbent that adsorbs and collects dioxins. However, whereas dioxins in an exhaust gas derived from an incineration plant are much contained in tar components in the exhaust gas, activated carbon would not necessarily enough remove the tar components themselves particularly in the case of exhaust gases containing large amounts of tar components. Moreover, pores may be clogged due to the deposition of the tar components onto the surfaces of activated carbon, which accounts for a deterioration of dioxin removability. In particular, the deterioration of removability due to tar components is considerable in the case of co-planar PCBs. Thus, an adsorbent which exhibits a stable removability regardless of whether the amount of tar components is large or small has been desired.

For prevention of the recomposition of dioxins, it is desirable to remove aromatic hydrocarbons, chlorine and the like, which are causal substances for the recomposition, before the passage through a temperature range of around 300° C. where the recomposition is highly likely to occur. Therefore, adsorbents usable at high temperatures of 400° C. or more are desirable. However, activated carbon is in danger of explosion at high temperatures and difficult to use at high temperatures.

As a result of energetically discussing the development of an adsorbent capable of sufficiently removing the dioxins in exhaust gas under the above circumstances, we inventors found out that certain kinds of inorganic adsorbents well adsorb tar components in the exhaust gas or dioxins contained therein, and are capable of sufficiently removing dioxins in the exhaust gas even when large amounts of tar components are contained in the exhaust gas, and moreover are usable at high temperatures and yet capable of sufficiently removing dioxins even at high temperatures. Thus, we inventors have completed this invention.

### DETAILED DESCRIPTION OF THE PREFERRED EMBODIMENTS

That is, the present invention provides an adsorbent for dioxins which contains at least one kind selected from among activated alumina, iron-type zeolite, aluminum-type zeolite, potassium-type zeolite and silica.

Fluids containing dioxins to be removed by the adsorbent of this invention are exemplified typically by exhaust gas from incineration plants. In addition to this, the adsorbent of this invention can also be applied to remove dioxins from gases containing dioxins or liquids containing dioxins, e.g., industrial waste water. The effects of this invention can better be exerted on exhaust gases containing larger amounts of tar components, exhaust gases in which the amount of tar components varies, exhaust gases of high temperatures, and the like.

Whereas the adsorbent of the invention contains activated alumina, iron-type zeolite, aluminum-type zeolite, potassium-type zeolite and silica, any one or ones selected from these kinds may be used either singly or in combination of two or more kinds.

Although the term “alumina” is herein a generic term for aluminum oxides, activated alumina is used in the present invention. The term “activated alumina” is herein a generic term for alumina which has adsorbability for tar components and which is one of inorganic porous materials, exemplified by γ-, η-, ρ-, χ-, κ-, θ-, δ- or other types of alumina. This activated alumina can be obtained as a low crystalline one by hydrolyzing an aluminum salt, or neutralizing with an acid in the case of alkali salts (e.g. sodium aluminate) or neutralizing with an alkali in the case of acidic salts (e.g. aluminum chloride), to obtain a precipitate of aluminum hydroxide such as boehmite gel, and by further performing drying process and heat treatment. The activated alumina is not particularly limited in type, configuration or the like, and may be given by commonly commercially available ones. Further, alumina containing silica may also be used.

The term “zeolite” generally refers to hydrated aluminosilicate, and it is preferable to use artificial zeolite other than natural zeolite and synthetic zeolite for the present invention. This artificial zeolite is a zeolite synthesized with coal ash used as a raw material, and is distinguished from synthetic zeolite that needs a raw material (silicic acid, aluminum hydroxide, etc.) having a certain level of purity. Then, this artificial zeolite contains intermediate products that have not completely been formed into zeolite or unburnt carbon components, where the purity as zeolite (rate of zeolite crystal content) falls intermediate between synthetic zeolite and natural zeolite. Accordingly, the artificial zeolite has specific features unlike synthetic zeolite and natural zeolite, for example, such useful characteristics as adsorbability like activated carbon or ion exchangeability, due to contained impurities (intermediate products, unburnt carbon components). The artificial zeolite has a cation exchange capacity equal to or about triple that of natural zeolite.

The method of fabricating the artificial zeolite is not particularly limited, and the artificial zeolite may be obtained by either so-called dry type or wet type method. This artificial zeolite can also be fabricated also from fly ash. For example, potassium-type artificial zeolite can be obtained by making fly ash of small particle size and a potassium hydroxide aqueous solution of about 2.5-3.5N concentration react with each other at about 90° C. for 12-28 hours, followed by washing and drying. Further, iron-type or aluminum-type artificial zeolite can be obtained by ion exchanging between potassium ions and iron-ions or aluminum-ions and thereby replacing with each other in an aqueous solution of an iron compound (iron nitrate, iron chloride, etc.) or aluminum salt, respectively. In this case, the fly ash is preferably derived from incineration of coal, pulp or the like, but those derived from incineration of general wastes or industrial wastes or the like are also usable.

The term “silica” is herein a generic term for silicon dioxides, whereas silica is exemplified particularly by noncrystalline silicic acid and silica gel in this invention. Silica gel is represented by a composition formula of SiO₂.nH₂O, and comes in either natural or synthetic products and available for this invention in either form. These silicas are not particularly limited in their type, and commonly commercially available ones are usable.

As described above, for this invention, activated alumina, iron-type zeolite, aluminum-type zeolite, potassium-type zeolite and silica are not particularly limited not only in type, grain size and the like, but also in their way of use. In addition, acid terra alba, apatite and the like may also be mentioned as examples that are capable of obtaining the same effects.

Now the way of use of the adsorbent according to the invention is explained For example, in the case of a large-scale incinerator, with the use of a powdered adsorbent, a method of blowing this adsorbent in and collecting the adsorbent by a dust collector is adoptable. For cases where exhaust gas of an incinerator unstable in combustion such as a small-scale batch type plastic incinerator, there can be used a method in which exhaust gas is passed through a powdered adsorbent or an adsorbent given by a sheet-membrane molded article of alumina fiber or silica fiber or an adsorbent given by a column filled with those alumina fiber or silica fiber.

The adsorbent of this invention can be used even at relatively high temperatures, for example, a high temperature of around 800° C. Therefore, with the adsorbent of the invention molded into a honeycombed shape, by changing the adsorbent into a secondary combustion chamber of the incinerator and operating the burner intermittently, it becomes possible to fulfill an operation free from replacement of the adsorbent for a long period since unburnt matters are collected from within the exhaust gas during the halt of the burner but accumulated unburnt matters are decomposed during the operation of the burner.

Furthermore, the adsorbent of the invention may contain other components within such a scope as the effects of the invention are not impaired. For example, calcium compounds or the like may be added. That is, in the case where a large amount of vinyl chloride or the like is contained in the wastes to be incinerated so that hydrogen chloride in the exhaust gas becomes high concentration, it becomes possible to remove dioxins in the exhaust gas to further lower concentrations when calcium compounds such as slaked lime or the like are used in combination as a neutralizer.

The adsorbent of this invention, upon contact with a fluid containing dioxins, adsorbs the dioxins in the fluid and removes the dioxins from within the fluid. The method of contact between the adsorbent of the invention and the fluid containing dioxins is not particularly limited. For example, a method in which the adsorbent of the invention is filled into a column and the fluid containing dioxins is passed through the column is available.

Referring now to the treatment of exhaust gas, the adsorbent of the invention can be used within a range of exhaust gas temperature below 900° C. However, when the exhaust gas temperature is about 300° C., recomposition of dioxins may occur. Therefore, the adsorbent is preferably used at a low temperature region of 100-250° C. or at a high temperature region of 400-900° C., more preferably, at a low temperature region of 120-180° C. or a high temperature region of 500-600° C.

Referring further to the way of use of the adsorbent of the invention, the adsorbent of the invention may be carried on a proper carrier. The method therefor is exemplified by forming a filter from a fibrous material such as glass fiber, silica fiber and Teflon fiber and the adsorbent of the invention, or by carrying the adsorbent on a ceramic honeycomb. Other methods are to make the exhaust gas containing dioxins passed through such a filter or honeycomb. The carrying method in this case is also not particularly limited. For example, the method may be immersing the carrier into a liquid in which the adsorbent of the invention has been dissolved or dispersed, and then drying the carrier.

As described hereinabove, the adsorbent of the invention can better adsorb and remove dioxins in a fluid, as compared with known adsorbents such as activated carbon. The effects of the invention can better be fulfilled particularly when exhaust gas contains large amounts of tar components, or when exhaust gas has tar components varying in amount, or when exhaust gas is of high temperature above 400° C., or the like. That is, whereas conventional adsorbents such as activated carbon has had such a drawback as surface pores may be clogged by tar components so that the adsorbability could not be exerted, the adsorbent of the invention makes it possible to remove large amounts of tar components in such a case, thereby allowing dioxins in the exhaust gas, even dioxins contained in the tar components, to be securely removed. Furthermore, not only co-planar PCBs but also PCBs can be removed.

Normally, larger amounts of tar components are exhausted when the carbon monoxide concentration due to incomplete combustion is high. In particular, large amounts of tar components are involved when the carbon monoxide concentration is beyond 150 ppm, in which case conventional adsorbents could not adsorb the tar components enough whereas the use of the adsorbent of the invention allows the tar components to be removed enough even when the carbon monoxide concentration is beyond 150 ppm. Further, since enough removal of dioxins is enabled regardless of whether the amount of tar components is large or small, the rate of removal of dioxins is stabilized against the amount of tar components contained in the exhaust gas. Accordingly, the adsorbent of the invention is usable also for the treatment of exhaust gas in an incinerator involving unstable combustion such as small-scale batch type plastic incinerators.

The adsorbent of the invention, by virtue of its large capacity for removal of tar components, is capable of stably removing dioxins even without the pre-treatment for exhaust gas. Also, the adsorbent of the invention, when filled into a column or the like through which exhaust gas is passed, is elongated in life to breakthrough.

Further, the adsorbent of the invention is usable also in cases where the exhaust gas is of high temperatures above 400° C., and yet enabled to securely remove the dioxins in the exhaust gas. Since enough remove of dioxins has been enabled over a range from low to high temperatures, it becomes possible to fulfill a stable removal against temperature variations in the exhaust gas, so that temperature control of the exhaust gas is facilitated. Besides, when the adsorbent of the invention is used simultaneously in two zones of different exhaust gas temperatures such as before and after the cooling tower, not only tar components of low boiling points but also tar components of high boiling points can securely be removed.

Furthermore, the adsorbent of the invention, having a thermal resistance, can be heated to 700-900° C., so that the adsorbent can be recycled by using decomposition reaction or dechlorinating reaction through such heating.

### EXAMPLES

The present invention is described below by way of examples thereof. However, these are given only by way of example, and the scope of the invention is never limited by those examples.

### Example 1

Granular γ-alumina having a mean particle size of 5 mm was filled into a column, and an exhaust gas with a temperature of 160° C. was passed through the column from a batch type small-scale incinerator at a space velocity of 10000 h⁻¹ (where the space velocity refers to the so-called SV value, determinable from an equation that SV=gas flow rate (m³/h⁻¹)+capacity of adsorbent (m³); the same applies hereinafter). Then, according to the “JIS K-0311, Measuring Method for Dioxins and Co-Planar PCBs in Exhaust Gas in Japan,” the amounts of dioxins before and after the treatment were measured, by which rates of removal of dioxins were determined.

The rate of removal was 88% at a CO amount of 60 ppm in the exhaust gas, while the rate of removal was 89% at a CO amount of 540 ppm.

### Example 2

In the same manner as in Example 1 except that the granular γ-alumina was replaced with a mixture of 50 wt % of acid terra alba and 50 wt % of granular apatite, rates of removal of dioxins were determined.

The rate of removal was 85% at a CO amount of 60 ppm in the exhaust gas, while the rate of removal was 82% at a CO amount of 540 ppm.

### Example 3

In the same manner as in Example 1 except that the granular γ-alumina was replaced with granular iron-type artificial zeolite, rates of removal of dioxins were determined.

The rate of removal was 89% at a CO amount of 60 ppm in the exhaust gas, while the rate of removal was 86% at a CO amount of 540 ppm.

### Comparative Example 1

In the same manner as in Example 1 except that the granular γ-alumina was replaced with granular activated carbon, rates of removal of dioxins were determined.

The rate of removal was 90% at a CO amount of 60 ppm in the exhaust gas, while the rate of removal was 74% at a CO amount of 540 ppm.

### Comparative Example 2

In the same manner as in Example 1 except that the granular γ-alumina was replaced with granular α-alumina, rates of removal of dioxins were determined.

The rate of removal was 34% at a CO amount of 60 ppm in the exhaust gas, while the rate of removal was 38% at a CO amount of 540 ppm.

### Example 4

Sheet-membrane fibrous activated alumina obtained by molding fibrous activated alumina (Al₂O₃:SiO₂=78:22, sintered at 950°) having a fiber diameter of 5-10 μm into a sheet membrane having a porosity of 88% was filled into a column, and an exhaust gas with a temperature of 180° C. was passed through the column from a batch type small-scale incinerator at a space velocity of 50000 h⁻¹. Then, the amount of dioxins before and after the treatment were measured, by which rates of removal of dioxins were determined.

The rate of removal was 61% at a CO amount of 46 ppm in the exhaust gas, while the rate of removal was 66% at a CO amount of 770 ppm.

### Example 5

In the same manner as in Example 4 except that the sheet-membrane fibrous activated alumina was replaced with sheet-membrane fibrous silica, rates of removal of dioxins were determined.

The rate of removal was 57% at a CO amount of 46 ppm in the exhaust gas, while the rate of removal was 55% at a CO amount of 770 ppm.

### Comparative Example 3

In the same manner as in Example 4 except that the sheet-membrane fibrous activated alumina was replaced with sheet-membrane fibrous α-alumina, rates of removal of dioxins were determined.

The rate of removal was 27% at a CO amount of 46 ppm in the exhaust gas, while the rate of removal was 25% at a CO amount of 770 ppm.

As described above, use of the adsorbent of the invention allows a superior removability even when a large amount of CO is contained in the exhaust gas, i.e., when a large amount of tar components is contained. Meanwhile, it is shown by the results of the foregoing Examples and Comparative Examples that use of activated carbon, indeed allowing a superior removability to be obtained for a small amount of CO in the exhaust gas, yet is low in removability at a large amount of CO. With the use of α-alumina, the rate of removal is low regardless of whether the amount of tar components is large or small.

### Example 6

While an exhaust gas derived from a large-scale stoker type incinerator and containing 25 ppm of CO was being passed through a ceramic high-temperature filter, powdered iron-type artificial zeolite was blown in at a place just before the filter at a rate of 0.2 g per m³ of exhaust gas, where the powdered iron-type artificial zeolite was collected by the filter. Amounts of dioxins before and after the filter were measured, by which rates of removal of dioxins were determined.

The rate of removal was 91% at an exhaust gas temperature of 160° C., while the rate of removal was 84% at an exhaust gas temperature of 600° C.

### Example 7

In the same manner as in Example 6 except that the powdered iron-type artificial zeolite was replaced with powdered γ-alumina, rates of removal of dioxins were determined.

The rate of removal was 83% at an exhaust gas temperature of 160° C., while the rate of removal was 79% at an exhaust gas temperature of 600° C.

### Comparative Example 4

In the same manner as in Example 6 except that the powdered iron-type artificial zeolite was replaced with powdered calcium-type artificial zeolite, rates of removal of dioxins were determined.

The rate of removal was 95% at an exhaust gas temperature of 160° C., showing a superior removability. Meanwhile, the rate of removal was 62% at an exhaust gas temperature of 600° C., with the result that only a low removability was able to be obtained, as compared with Example 6 and Example 7.

### Example 8

A honeycombed molded article of granular aluminum-type artificial zeolite was filled into a gas flow passage provided within a secondary combustion chamber of a batch type small-scale incinerator. Then, an exhaust gas derived from a primary combustion chamber of the batch type small-scale incinerator and containing 38 ppm of CO and having a temperature of 400-800° C. was passed through the filling point at a space velocity of 200000 h⁻¹. Then, the amounts of dioxins before and after the secondary combustion chamber were measured, by which a rate of removal of dioxins was determined. The rate of removal was 60%.

### Example 9

A honeycombed molded article of granular potassium-type artificial zeolite was filled into a gas flow passage provided within a secondary combustion chamber of a batch type small-scale incinerator. Then, an exhaust gas derived from a primary combustion chamber of the batch type small-scale incinerator and containing 45 ppm of CO and having a temperature of 400-800° C. was passed through the filling point at a space velocity of 200000 h⁻¹. Then, the amounts of dioxins before and after the secondary combustion chamber were measured, by which a rate of removal of dioxins was determined. The rate of removal was 55%.

### Comparative Example 5

A honeycombed molded article of granular calcium-type artificial zeolite was filled into a gas flow passage provided within a secondary combustion chamber of a batch type small-scale incinerator. Then, an exhaust gas derived from a primary combustion chamber of the batch type small-scale incinerator and containing 31 ppm of CO and having a temperature of 400-800° C. was passed through the filling point at a space velocity of 200000 h⁻¹. Then, the amounts of dioxins before and after the secondary combustion chamber were measured, by which a rate of removal of dioxins was determined. The rate of removal was 33%.

As described above, Example 8 or Example 9 according to the adsorbent of the invention showed superior removabilities, while Comparative Example using calcium-type artificial zeolite showed a low removability.

### Example 10

An exhaust gas derived from a large-scale stoker type incinerator and containing 15 ppm of CO was passed through a cooling tower. In this case, granular γ-alumina was filled at the preceding stage of the cooling tower, and the exhaust gas having a temperature of 500° C. was passed through this filling point at a space velocity of 50000 h⁻¹. Further, powdered activated carbon with 10 wt % of powdered γ-alumina mixed therewith was blown in at the succeeding stage of the cooling tower at a 0.2 g per m³ of exhaust gas, where dioxins were collected by a bag filter. At this time point, the exhaust gas temperature was 200° C. Then, the amounts of dioxins before and after the cooling tower were measured, by which a rate of removal of dioxins was determined. The rate of removal was 97%.

What is claimed is:

1. An adsorbent for dioxins which contains at least one kind selected from among activated alumina, iron-type zeolite, aluminum-type zeolite, potassium-type zeolite and silica.

2. The adsorbent for dioxins as defined in claim 1, further including a calcium compound.

3. The adsorbent for dioxins as defined in claim 1, wherein each of the zeolites is an artificial zeolite.
